(19) United States
(12) Patent Application Publication
(10) Pub. No.: US 2008/0084709 A1
(43) Pub. Date: Apr. 10, 2008

(54) Light Guide Plate and Back-Light Module Having Light Guide Plate

(75) Inventors: Yu-Tang Li, Hsinchu Hsien (TW); Cheng-Ling Yang, Hsinchu Hsien (TW); Chang-Sheng Chu, Hsinchu Hsien (TW); Hsiu-Hsiang Chen, Hsinchu Hsien (TW); Ching-Chin Wu, Hsinchu Hsien (TW)

Correspondence Address: WPAT, PC;INTELLECTUAL PROPERTY ATTORNEYS, 2030 MAIN STREET, SUITE 1300, IRVINE, CA, 92614, US

(73) Assignee: INDUSTRIAL TECHNOLOGY RESEARCH INSTITUTE, Hsinchu Hsien (TW)

(21) Appl. No.: 11/768,655

(22) Filed: Jun. 26, 2007

(30) Foreign Application Priority Data
Oct. 4, 2006 (TW) 095136905

(51) Int. Cl. F21V 8/00; F21V 7/04

(52) U.S. Cl. 362/616; 362/621; 362/608; 362/625

(57) ABSTRACT

A light guide plate, for use with a back-light module for seasonal scanning in dividing zones, includes a light-pervious substrate having a plurality of dividing blocks formed thereon, an optical grating structure disposed on light incident surface of each of the dividing blocks for allowing light to enter, and a light diffusion structure disposed on an optical surface of each of the dividing blocks for diffusing the light. As the light-pervious substrate is adapted for seasonal scanning in different zones, the provision of the optical grating structure can shorten the light mixing distance while the light diffusion structure can evenly emit and spread the light throughout the light guide plate to solve the drawbacks of the prior techniques. Further, a back-light module having the light guide plate is provided.

### BACKGROUND OF THE INVENTION

1. Field of the Invention

The present invention relates generally to an optical technique, and more particularly to a light guide plate and a back-light module having the light guide plate.

2. Description of Related Art

As a key component of a liquid crystal display (LCD), the back-light module mainly comprises a LED/tube light source, a light guide plate, a diffusion sheet, a reflector sheet, and an optical film such as a brightness enhancement film (BEF) or a DBEF, wherein the light guide plate is a key factor affecting quality of the medium and small sized back-light modules.

Generally, there are two types of back-light modules: front type and back type. According to the position of the light source of the back-light module, the back type back-light module can further be a kind of edge lighting back-light module. The edge lighting back-light module is usually applied in medium and small sized back-light modules under 18-inch, which is characterized by light weight, small size and low power consumption. Currently, there have appeared large sized edge lighting back-light modules. In combination with the LED backlight, LCD seasonal scanning is one method to overcome the image persistence effect, enhance light utility and color gamut. Related techniques are disclosed by such as U.S. Pat. No. 4,043,636, No. 5,396,350, No. 6,679,613, No. 6,671,013, No. 6,700,634, No. 6,867,828, No. 6,979,112, No. 6,971,782, No. 6,981,792, No. 6,981,791, No. 6,991,358 and No. 6,883,934.

As disclosed by U.S. Pat. No. 4,043,636, a light guide plate having a cone-shaped structure on surface thereof is used to increase light emitting range. U.S. Pat. No. 5,396,350 discloses a light guide plate having inverted cone-shaped structures on surface thereof, each of the inverted cone-shaped structures is used as a mircoprism corresponding to a microlens. As disclosed by U.S. Pat. No. 6,679,613, a light-shielding sheet is disposed below the light diffusion sheet such that the light can be incident to the light diffusion sheet through the light-shielding sheet. U.S. Pat. No. 6,671,013 discloses a light guide plate having a plurality of 3-dimensional micro-reflecting structures disposed at back surface thereof. Each of the micro-reflecting structures has four oblique surfaces. Incident lights are guided by two of the oblique surfaces, and then respectively reflected by the other two oblique surfaces, thereby diffusing the incident light. According to U.S. Pat. No. 6,700,634, an oblique surface structure is disposed on front surface of a light guide plate for increasing the light emitting range. According to U.S. Pat. No. 6,867,828, an oblique surface structure is disposed on back surface of a light guide plate such that light can be incident to the inside of the light guide plate after several times of reflection and refraction. As disclosed by U.S. Pat. No. 6,979,112, a plurality of micro-lens structure arranged in an array is disposed on surface of a light guide plate. As disclosed by U.S. Pat. No. 6,971,782, a plurality of concave structures is disposed on surface of a light guide plate, tilt angle inside the concave structures is in the range of −18° and +18°. According to U.S. Pat. No. 6,981,792, a light directivity adjusting sheet having pyramid structures is disposed on light emitting surface of a light guide plate, the pitch between adjacent tip portions of the pyramid structures are preferably in the range of about 50 to 80 μm. U.S. Pat. No. 6,981,791 discloses a light guide plate having sawtooth structure disposed on surface thereof and reflection polarizing plates respectively disposed at two sides thereof.

However, the above-mentioned multi-surface micro structures such as the lens array and the pyramid structure are complex, which are difficult to be fabricated and not suitable to be fabricated in batch-type, thereby resulting in a high fabrication cost. Meanwhile, the micro-reflection structures of the above-mentioned cases need to meet special design conditions, which accordingly complicates the design. Also, the obtained micro-reflection structure can only tolerate too small tolerances. Even if relative positions between the LED and the micro-reflecting structure have tiny error, it will not be possible to completely guide the light. Moreover, as the light needs to experience several times of reflection and refraction before being incident into the light guide plate, a lot of energy loss is caused, thereby reducing the output light energy. Furthermore, due to too big light emitting range, light cannot be concentrated in the light guiding region, thereby causing the light leakage problem. Therefore, it is not only difficult to fabricate the above structures, it is also difficult to prevent fabrication error, thereby resulting in poor light output uniformity.

U.S. Pat. No. 6,991,358 discloses a light guide plate having a light incident surface disposed at one side thereof and a light output surface adjacent to the light incident surface. The light incident surface is flat, while the light output surface (bottom surface of the light guide plate) has a V-shaped groove structure. When the light from the light source is incident to the side surface of the light guide plate, complete reflection phenomenon can occur on side surface of the V-shaped groove structure. As a result, most of the light are outputted over the V-shaped groove structure, which accordingly generate bright fringes on the light guide plate.

According to U.S. Pat. No. 6,883,934, a circular-arc shaped lens, or a cone-shaped lens, or a plurality of sawtooth-shaped lens are disposed at light incident position. However, external light aligning design is required in this patent. Further, the above-mentioned problems such as complicated fabrication, difficult error control and poor light output uniformity also exist in this patent.

Moreover, image persistence occurring in LCDs while displaying dynamic images is conventionally solved by high-speed liquid crystal and special driving technique. However, obvious flickering or color breaking phenomenon still exist while the whole image flickers. Thus, not only the overall image impression is adversely affected, the light utility and image resolution are also lower. In addition, high power consumption results in high operation cost of the display.

Therefore, there is a need to provide a light guide plate to solve the above problems.

### SUMMARY OF THE INVENTION

An objective of the present invention is to provide a light guide plate and a back-light module having the light guide plate for seasonal scanning in dividing zones.

Another objective of the present invention is to provide a light guide plate and a back-light module having the light guide plate for shortening the light mixing distance.

Still another objective of the present invention is to provide a light guide plate and a back-light module having the light guide plate eliminating the need of light source aligning design.

Still another objective of the present invention is to provide a light guide plate and a back-light module having the light guide plate for increasing the overall image impression.

A further objective of the present invention is to provide a light guide plate and a back-light module having the light guide plate for increasing the light utility.

Still another objective of the present invention is to provide a light guide plate and a back-light module having the light guide plate for saving power consumption.

A further objective of the present invention is to provide a light guide plate and a back-light module having the light guide plate for simplifying structure of the light guide plate while uniformizing the light.

In order to attain the above and other objectives, the present invention discloses a light guide plate and a back-light module having the light guide plate for seasonal scanning in dividing zones.

Meanwhile, the present invention provides back-light modules using the above-mentioned light guide plates.

### BRIEF DESCRIPTION OF DRAWINGS

FIGS. 1A and 1B are diagrams of a light guide plate according to a first embodiment of the present invention, wherein FIG. 1B is a side view of the light guide plate of FIG. 1A;

FIG. 2 is a partial bottom view of the light guide plate of FIG. 1A;

FIGS. 3A and 3B are partially enlarged diagrams of the light guide plate of FIG. 1A;

FIG. 4 is a diagram of a back-light module having the light guide plate according to the first embodiment of the present invention;

FIGS. 5A and 5B are diagrams of a light guide plate according to a second embodiment of the present invention, wherein FIG. 5B is a side view of the light guide plate of FIG. 5A;

FIG. 6 is a partially enlarged diagram of the light guide plate of FIG. 5A; and

FIG. 7 is a diagram of a back-light module having the light guide plate according to a second embodiment of the present invention.

### DETAILED DESCRIPTION OF PREFERRED EMBODIMENTS

In a preferred embodiment, the light guide plate comprises: a light-pervious substrate, which has a plurality of dividing portions for dividing the light-pervious substrate into a plurality of dividing blocks, each of the dividing blocks having a light incident surface, a first optical surface and a second optical surface opposed to the first optical surface; an optical grating structure disposed on the light incident surface for allowing the light to enter; and a light diffusion structure disposed on the second optical surface for diffusing the light such that the light can be uniformly scattered out of the light-pervious substrate through the first optical surface. Preferably, the dividing portions are concavely disposed on the second optical surface close to the first optical surface. The dividing portions can be of inverted-V shape, and arranged in a row with the same interval between every adjacent two dividing portions.

In another preferred embodiment, the light guiding plate comprises: a light-pervious substrate constituted by a plurality of dividing blocks arranged at intervals, each of the dividing blocks having a light incident surface, a first optical surface and a second optical surface opposed to the first optical surface; an optical grating structure disposed on the light incident surface for allowing the light to enter; and a light diffusion structure disposed on the second optical surface for diffusing the light such that the light can be uniformly scattered out of the light-pervious substrate through the first optical surface.

Preferably, the light-pervious substrate is a transparent substrate. The optical grating structure is a sinusoidal grating structure or wave-shaped structure. When the optical grating structure is wave-shaped, the extending direction of the optical grating structure is perpendicular to the first optical surface and the second optical surface. The light diffusion structure is at least one of a lens array microstructure and a barrel-shaped array microstructure protrudingly disposed on the second optical surface. Therein, height change and arrangement change of the optical grating structure protrudingly disposed on the second optical surface meet the equation: H(x)=A+(B−A)(EXP(x−L)̂P−1)/(e−1), in which A refers to initial height of the light diffusion structure, B refers to end height of the light diffusion structure, e refers to natural log, L refers to length of the light-pervious substrate, P refers to power, x refers to position of the light diffusion structure, and H(x) refers to height of the light diffusion structure at position x.

The abovementioned light guide plates can further comprise a light mixing region disposed on the second optical surface. The light mixing region can be disposed on edge of the second optical surface close to the light incident surface, for example.

The following illustrative embodiments are provided to illustrate the disclosure of the present invention, these and other advantages and effects can be apparent to those skilled in the art after reading the disclosure of this specification. The present invention can also be performed or applied by other different embodiments. The details of the specification may be on the basis of different points and applications, and numerous modifications and variations can be made without departing from the spirit of the present invention.

### First Embodiment

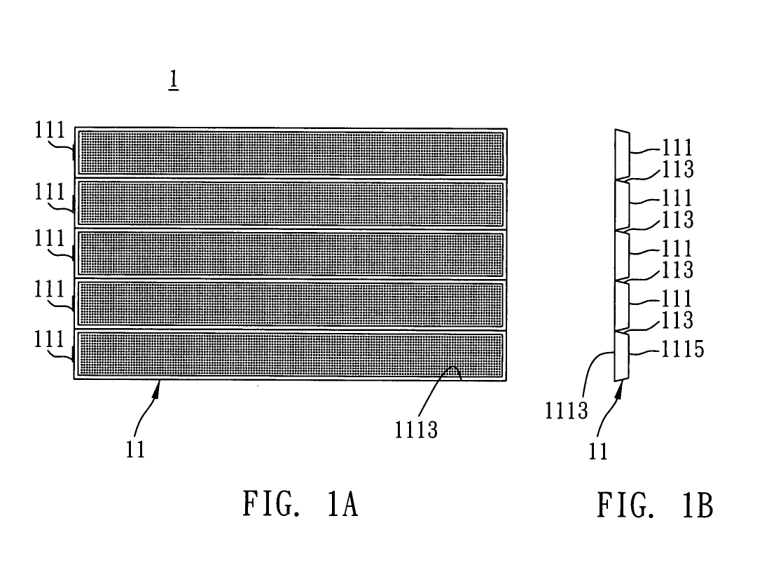

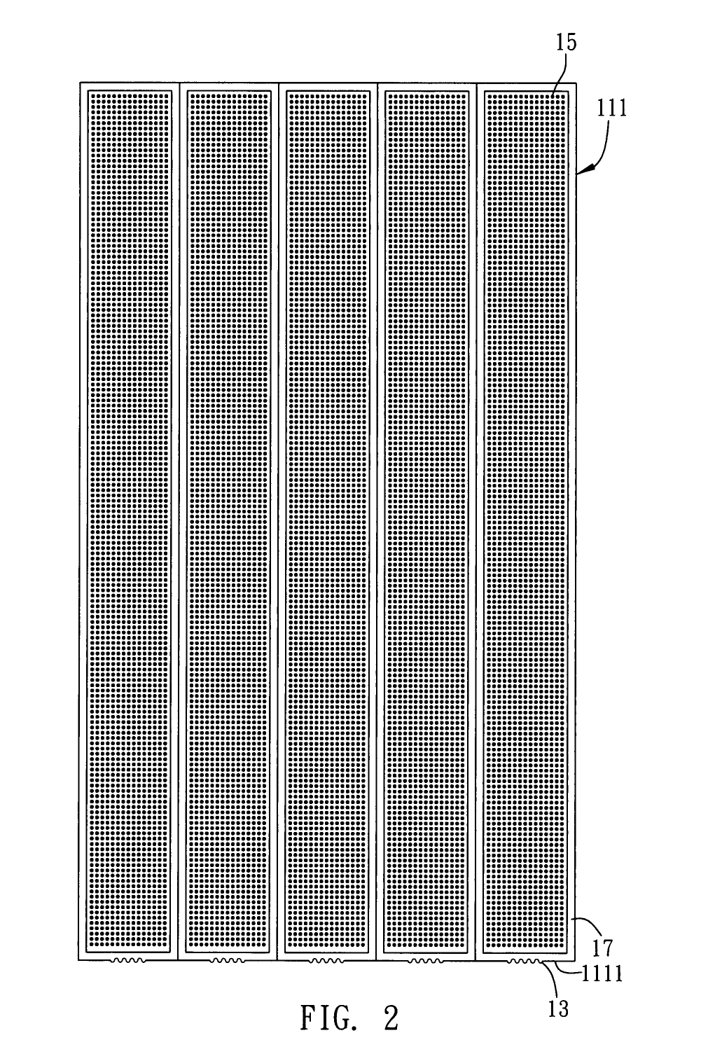

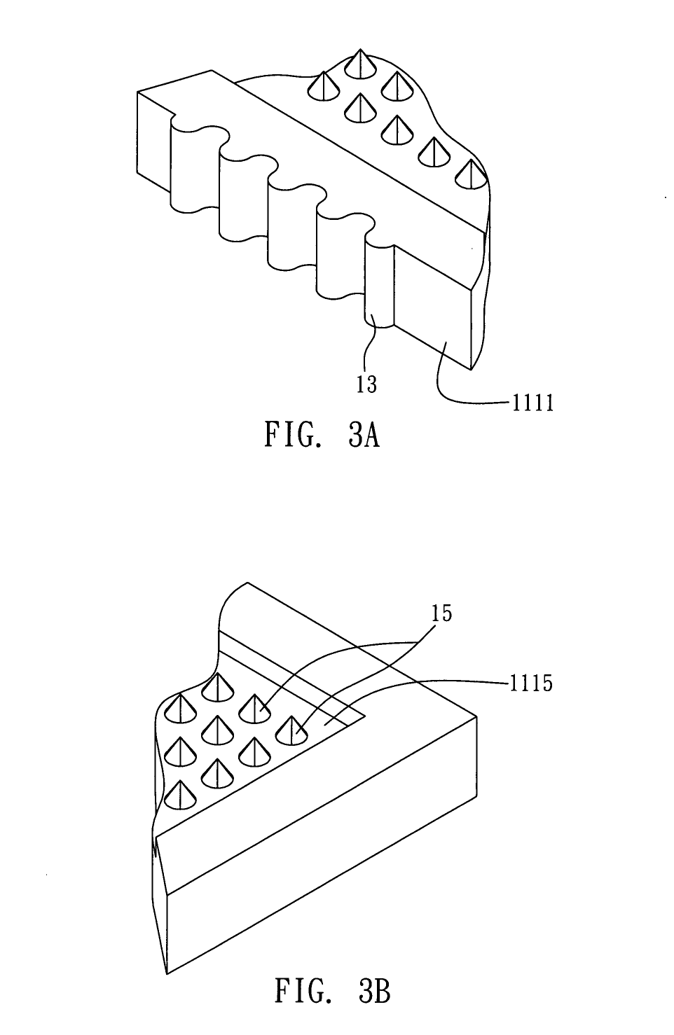

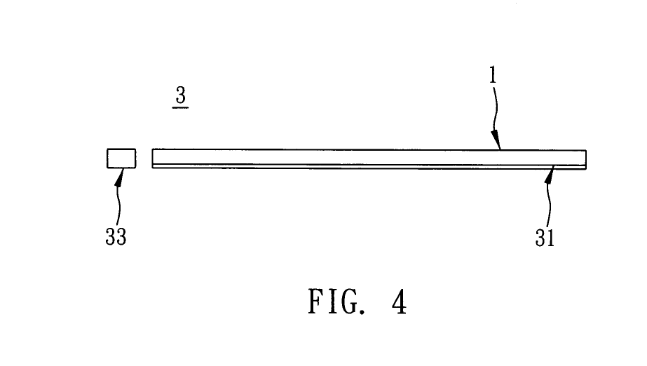

FIGS. 1A to 3B are diagrams showing a light guide plate according to a first embodiment of the present invention, wherein FIG. 1B is a side view of the light guide plate of FIG. 1A, FIG. 2 is a partial bottom view of the light guide plate of FIG. 1A, FIGS. 3A and 3B are partially enlarged diagrams of the light guide plate of FIG. 1A. FIG. 4 is a diagram of a back-light module having the light guide plate according to a first embodiment of the present invention.

As shown in FIG. 1A, FIG. 1B and FIG. 2, the light guide plate 1 comprises a light-pervious substrate 11, an optical grating structure 13 and a light diffusion structure 15.

The light-pervious substrate 11 has a plurality of dividing portions 113 for dividing the light-pervious substrate 11 into a plurality of dividing blocks 111. Each of the dividing blocks 111 has a light incident surface 1111, a first optical surface 1113, and a second optical surface 1115 opposed to the first optical surface 1113. In the present embodiment, the light-pervious substrate 11 can be a transparent substrate, a transparent film or the like. The dividing portions 113 are concavely disposed on the second optical surface 1115 and close to the first optical surface 1113. Further, the dividing portions 1113 have an inverted V-shaped structure and arranged in a row with the same interval between every adjacent two dividing portions. The light incident surface 1111 is used for receiving incident light (not shown). The first optical surface 1113 is disposed on the top surface of the light-pervious substrate 11, which can be used as a light output surface. The second optical surface 1115 is disposed on the bottom surface of the light-pervious substrate 11, which can be used as for example a light diffusing surface. As the light-pervious substrate 11 has a plurality of dividing blocks, it can be used with a back-light module for seasonal scanning in dividing zones, thereby preventing obvious flicking and color breaking phenomenon from occurring to images.

It should be noted that the number of the blocks 111 is not limited to the present embodiment. In addition, the dividing blocks 111 of the light-pervious substrate 11 can be arranged with different intervals between adjacent two dividing blocks.

The optical grating structure 13 is disposed on the light incident surface 1111 for allowing the light to enter. As shown in FIG. 3A, the optical grating structure 13 in the present embodiment is a sinusoidal grating structure. The optical grating structure 13 can shorten the light mixing distance, and such as an LED light source (not shown) can be disposed a position corresponding to the optical grating structure 13 as long as the light from the light source (not shown) can pass through the optical grating structure 13 and enter the light-pervious substrate 11. Special light source aligning design is not needed in the present embodiment.

The light diffusion structure 15 is disposed on the second optical surface 1115 for diffusing the light such that the light can be evenly scattered out of the light-pervious substrate 11 through the first optical surface 1113. Referring to FIG. 3B, the light diffusion structure 15 is protrudingly disposed on the second optical surface 1115. The light diffusion structure 15 can be a barrel-shaped microstructure array or the like. Meanwhile, the height change and the arrangement change of the light diffusion structure 15 on the second optical surface 1115 meet the following equation:

H(x)=A+(B−A)(EXP(x−L)̂P−1)/(e−1)

Wherein A refers to initial height of the light diffusion structure 15, B refers to end height of the light diffusion structure 15, e refers to natural log, L refers to length of the light-pervious substrate 11, P refers to power, x refers to position of the light diffusion structure 15, and H(x) refers to height of the light diffusion structure 15 at position x.

It should be noted that diffusivity of the light diffusion structure 15 can be adjusted by choosing appropriate height change and arrangement change of the light diffusion structure 15 so as to meet different requirements of various products. As it is well understood by those skilled in the art, detailed description of it is omitted.

Through the light diffusion structure 15, light entering into the substrate can be evenly diffused.

Referring back to FIG. 2, the light guide plate 1 can further has a light mixing region 17 disposed on the second optical surface 1115. In the present embodiment, the light mixing region 17 is disposed on an edge of the second optical surface 1115 close to the light incident surface 1111. The light mixing region 17 has a part of light diffusion structure 15.

In addition, by using super-precision machining technique such as a formed mono crystalline diamond tool to process a metallic mold, in combination with a rolling forming technique for UV curving so as to transfer the microstructure of the mold to the optical substrate, the light guide plate 1 can be fabricated in batch-type. Of course, the machining technique and the forming technique are not limited to the present embodiment. As related machining principle and technique are well known in the art, detailed description of them is omitted.

Referring to FIG. 4, the present invention provides a back-light module 3 having the light guide plate 1 according to a first embodiment. The back-light module 3 can be adapted for seasonal scanning in dividing zones. The back-light module 3 can comprise such as the light guide plate 1, a reflector 31 disposed below the light guide plate 1, at least one light source 33 disposed at one side of the light guide plate 1. It should be noted that structure of the back-light module 3 is not limited to the present embodiment. Other structures of edge lighting LCD back-light module as disclosed by U.S. Pat. No. 6,648,485, Taiwan Patent Certification No. 1255566, and Taiwan Patent Publication No. 594076 can be applied in the present invention. As related structures and operation principles are well known by those skilled in the art, detailed description of them is omitted.

Compared with the prior art, the present invention uses a light guide plate having a plurality of dividing blocks for back-light application of seasonal scanning in dividing zones, thereby overcoming the obvious flickering and color breaking phenomenon of the prior art. Meanwhile, each of the dividing blocks has a sinusoidal grating structure disposed on the light incident surface thereof, which can shorten the light mixing distance and eliminates the need of light source aligning design. Moreover, the light diffusion structure disposed on backside of the light guide plate is easy to be fabricate and can evenly scatter the light throughout the light guide plate.

Meanwhile, the present invention can be used in combination with a RGB LED light source and an LCD panel for quick seasonal scanning in dividing zones. In addition, if seasonal scan backlight is applied, color filter is not needed in an LCD panel and it not necessary to form mixing light by RGB pixels. As a result, the light utility is enhanced, the power consumption is decreased, the image resolution is greatly increased and the display cost is decreased. Further, by quickly switching on and off the backlight source, image persistence caused by slowly responding speed of the LCD of the prior art can be removed so as to enhance the image quality. Meanwhile, the region division scanning in combination with LCD can modulate brightness of the light source in different dividing blocks so as to save power consumption. When the light guide plate is used in a back-light module, the light utility can be increase, module construction can be simplified, the module cost can be decreased and the power consumption can be saved.

Therefore, the light guide plate of the present invention and the back-light module having the light guide plate of the present invention have simplified construction, which can be used to perform seasonal scanning in dividing zones and shorten the light mixing distance. In combination with region division scan driving, the back-light module having the light guide plate can save power consumption.

In addition, the light guide plate and the back-light module having the light guide plate can be used in combination with optical films. For example, a protection film or a diffusing film can be disposed on the back-light module 3 for increasing the brightness of the output light and light uniformity.

### Second Embodiment

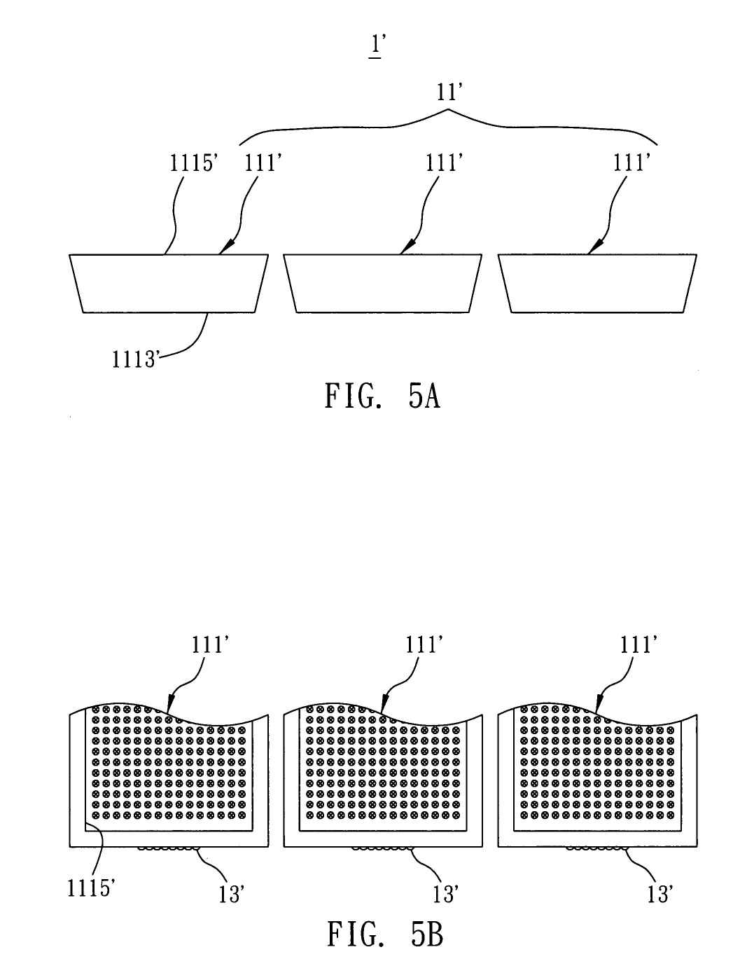

FIGS. 5A to 7 are diagrams of a light guide plate and a back-light module having the light guide plate according to a second embodiment of the present invention, wherein components same as or similar to those in the first embodiments are denoted by same or similar symbols.

The main difference of the second embodiment from the first embodiment is the light-pervious substrate is constituted by a plurality of dividing blocks arranged at intervals.

As shown in FIG. 5A, a light guide plate 1′ comprises a light-pervious substrate 11′ constituted by five dividing blocks 111′. As shown in FIG. 5B, each of the dividing blocks 111′ is trapezoid shaped, but it is not limited thereto. The dividing blocks are arranged in a row with the same interval between every adjacent two dividing blocks.

Moreover, the positions of the first optical surface 1113′ and the second optical surface 1115′ in the present embodiment are opposed to the positions of the first optical surface 1113 and the second optical surface 1115 in the first embodiment. In other words, the configuration for region division scanning can be disposed on top surface or bottom surface of the light guide plate.

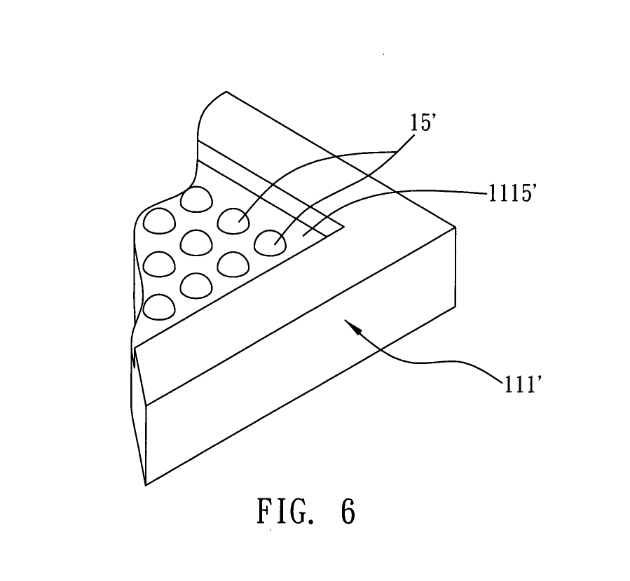

In the present embodiment, the optical grating structure 13′ is wave shaped, extending in a direction perpendicular to the first optical surface 1113′ and the second optical surface 1115′. In addition, as shown in FIG. 6, the light diffusion structure 15′ is protrudingly disposed on the second optical surface 1115′ and can have a lens array microstructure or the like. Thus, the incident light can be uniformly diffused by the lens aberration effect of the light diffusion structure 15′.

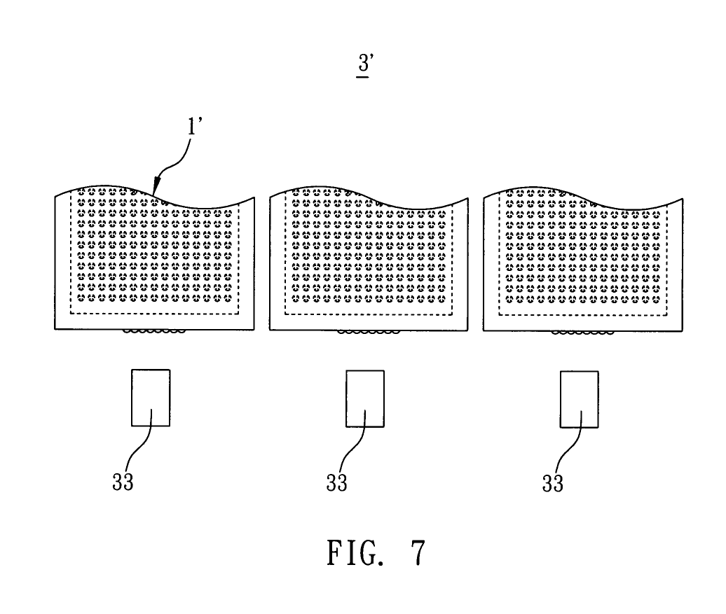

FIG. 7 is a side view of a back-light module having the light guide plate according to a second embodiment. As shown in FIG. 7, the back-light module 3′ at least comprises the light guide plate 1′, and other components such as the light source 33 disposed at one side of the light guide plate 1′. Of course, the back-light module 3′ can have other similar structures that can perform seasonal scanning in dividing zones.

Of course, structure of the light guide plate can have some change. For example, diffusion structure of the first embodiment can have a column shape or the like according to the practical need. In other embodiments, the light guide plate can be composed of different structures of the abovementioned embodiments.

Meanwhile, in other embodiments, the light diffusion structure can have lens array microstructure and barrel-shaped array microstructure at the same time. Further, those skilled in the art can dispose two or more overlapped light guide plates on the back-light module.

Therefore, the light guide plate of the present invention comprises a light-pervious substrate having a plurality of dividing blocks, an optical grating structure disposed on the light incident surface of each of the blocks, and a light diffusion structure disposed on an optical surface of each of the blocks which is used for receiving the incident light. Therein, the light-pervious substrate is adapted for seasonal scanning in dividing zones; the optical grating structure can shorten the light mixing distance; and the light diffusion structure can uniformly scatter the light throughout the light guide plate, thereby overcoming the conventional drawbacks.

The above-described descriptions of the detailed embodiments are only to illustrate the preferred implementation according to the present invention, and it is not to limit the scope of the present invention, Accordingly, all modifications and variations completed by those with ordinary skill in the art should fall within the scope of present invention defined by the appended claims.

What is claimed is:

1. A light guide plate for use with a back-light module for seasonal scanning in dividing zones, the light guide plate comprising:
a light-pervious substrate, having a plurality of dividing portions and a plurality of dividing blocks divided by the dividing portions, wherein each of the dividing blocks has a light incident surface, a first optical surface and a second optical surface opposed to the first optical surface;
an optical grating structure disposed on the light incident surfaces of the dividing blocks for allowing light to enter; and
a light diffusion structure disposed on the second optical surfaces of the dividing blocks for diffusing the light such that the light can be uniformly scattered out of the light-pervious substrate through the first optical surfaces.

2. The light guide plate of claim 1, wherein the light-pervious substrate is a transparent substrate.

3. The light guide plate of claim 1, wherein the optical grating structure is a sinusoidal grating structure.

4. The light guide plate of claim 1, wherein the optical grating structure is wave shaped.

5. The light guide plate of claim 1, wherein the optical grating structure is wave shaped, extending in a direction perpendicular to the first and second optical surfaces.

6. The light guide plate of claim 1, wherein the light diffusion structure comprises at least one of a lens array microstructure and a barrel-shaped array microstructure protrudingly disposed on the second optical surface.

7. The light guide plate of claim 1, wherein the light diffusion structure is protrudingly disposed on the second optical surface, height change and arrangement change of which meet the equation: H(x)=A+(B−A)(EXP(x−L)̂P−1)/(e−1), in which A refers to initial height of the light diffusion structure, B refers to end height of the light diffusion structure, e refers to natural log, L refers to length of the light-pervious substrate, P refers to power, x refers to position of the light diffusion structure, and H(x) refers to height of the light diffusion structure at position x.

8. The light guide plate of claim 1, wherein, the dividing portions are concavely disposed on the second optical surface close to the first optical surface.

9. The light guide plate of claim 8, wherein the dividing portions are inverted-V shaped.

10. The light guide plate of claim 1, wherein the dividing portions are arranged in a row with the same interval between every adjacent two dividing portions.

11. The light guide plate of claim 1, further comprising a light mixing region disposed on the second optical surface.

12. The light guide plate of claim 11, wherein the light mixing region is disposed on edge of the second optical surface close to the light incident surface.

13. A back-light module using the light guide plate of claim 1.

14. A light guide plate for use with a back-light module for seasonal scanning in dividing zones, the light guide plate comprising:
a light-pervious substrate having a plurality of dividing blocks arranged at intervals, each of the dividing blocks having a light incident surface, a first optical surface and a second optical surface opposed to the first optical surface;
an optical grating structure disposed on the light incident surfaces of the dividing blocks for allowing light to enter; and
a light diffusion structure disposed on the second optical surfaces for diffusing the light such that the light can be uniformly scattered out of the light-pervious substrate through the first optical surfaces.

15. The light guide plate of claim 14, wherein the light-pervious substrate is a transparent substrate.

16. The light guide plate of claim 14, wherein each of the dividing blocks is trapezoidal shaped.

17. The light guide plate of claim 14, wherein the dividing blocks are spaced equally in a row.

18. The light guide plate of claim 14, wherein the optical grating structure is wave shaped.

19. The light guide plate of claim 14, wherein the optical grating structure is wave shaped, extending in a direction perpendicular to the first and second optical surfaces.

20. The light guide plate of claim 14, wherein the optical grating structure is a sinusoidal grating structure.

21. The light guide plate of claim 14, wherein the light diffusion structure comprises at least one of a lens array microstructure and a barrel-shaped array microstructure protrudingly disposed on the second optical surface.

22. The light guide plate of claim 14, wherein the light diffusion structure is protrudingly disposed on the second optical surface, height change and arrangement change of which meet the equation: H(x)=A+(B−A)(EXP(x−L)̂P−1)/(e−1), in which A refers to initial height of the light diffusion structure, B refers to end height of the light diffusion structure, B refers to natural log, L refers to length of the light-pervious substrate, P refers to power, x refers to position of the light diffusion structure, and H(x) refers to height of the light diffusion structure at position x.

23. The light guide plate of claim 14, further comprising a light mixing region disposed on the second optical surface.

24. The light guide plate of claim 23, wherein the light mixing regions is disposed on edge of the second optical surface close to the second optical surface.

25. A back-light module using the light guide plate of claim 14.
